(19) United States
(12) Patent Application Publication
(10) Pub. No.: US 2020/0162378 A1
(43) Pub. Date: May 21, 2020

(54) Method And System For Accelerating Interactive-Streaming-Based Applications Via Cloud Overlay Networks

(71) Applicants: Zhan Ma, Fremont, CA (US); Xu Zhang, Nanjing (CN); Kai Yang, Nanjing (CN); Yangchao Zhao, Nanjing (CN)

(72) Inventors: Zhan Ma, Fremont, CA (US); Xu Zhang, Nanjing (CN); Kai Yang, Nanjing (CN); Yangchao Zhao, Nanjing (CN)

(21) Appl. No.: 16/687,583

(22) Filed: Nov. 18, 2019

Related U.S. Application Data
(60) Provisional application No. 62/769,548, filed on Nov. 19, 2018.

(51) Int. Cl. H04L 12/715; H04L 29/08; H04L 12/721; H04L 12/727

(52) U.S. Cl. CPC H04L 45/64; H04L 45/121; H04L 45/124; H04L 67/327

(57) ABSTRACT

Interactive-streaming-based applications, such as cloud gaming, giga-pixel streaming and virtual reality, have rigorous requirements on the network latency, which can be satisfied by routing users' requests over an overlay network. Existing overlay routing strategies suffer from high deployment and maintenance costs. An optimized cloud overlay routing system and method is discussed herein, which maximizes the number of user requests for the interactive-streaming-based applications to be served, lower the deployment and maintenance costs for the overlay services, reduce the overall network delay, and balance the network loads by bypassing busy underlay links.

### CROSS-REFERENCE TO RELATED APPLICATIONS

This application claims priority to the following patent application, which is hereby incorporated by reference in its entirety for all purposes: U.S. Patent Provisional Application No. 62/769548, filed on Nov. 19, 2018.

### TECHNICAL FIELD

This invention relates to computer networks, and more particularly to overlay routing methods and systems for low-latency interactive-streaming-based applications.

### BACKGROUND

Interactive-streaming-based applications, such as cloud gaming, giga-pixel streaming and virtual reality, have rigorous requirements on the network latency. The strong interactive attribute of these applications makes users' Quality of Experience (QoE) highly depend on network delay. The underlay path from the remote cloud server hosting interactive-streaming-based video applications (e.g., cloud gaming services) to the users would experience long network delay if network congestion occurs in the underlay links. In addition, if the underlay links fail, the interactive-streaming-based applications would experience long recovery time.

In order to improve users' QoE, many service providers resort to Content Delivery Networks (CDN) by pre-caching contents in an edge that is close to the users in proximity. That normally would be effective when the users request static contents such as video-on-demand (VoD) or pictures. However, the dynamic nature of interactive-streaming-based video applications makes CDN ineffective given the more rigorous delay limit in such use cases. An alternative solution is to construct an overlay network and reroute users' requests by relaying them via overlay nodes.

Overlay Service Providers (OSPs) can take advantage of public cloud resources to build their overlay network by renting Virtual Machines (VMs) or dockers from one or even multiple clouds as overlay nodes. Moreover, the connection between the overlay nodes is using the underlay path across the public Internet. Without deploying dedicated infrastructures and building dedicated lines to connect them, OSP can have lower short-term deployment costs. In the meanwhile, OSPs do not need to maintain the overlay nodes themselves, which would be left to the cloud providers. In this way, building an overlay network in the cloud can lower the long-term operational cost.

A key component to a cloud overlay network is to design an optimal overlay routing algorithm. The existing overlay routing solutions are based on a pre-known router-level topology with the assumption that the underlay routing is shortest-path-first based. The assumption does not always hold in the Internet, making those solutions less efficient in practice. Other solutions propose to schedule the users' requests based on an overlay-node-level topology, which, however, ignore the possibility that multiple overlay paths may share the same underlay links, as OSPs have no control on how packets are routed in the underlying network between two overlay nodes.

### BRIEF SUMMARY

Interactive-streaming-based applications, such as cloud gaming, giga-pixel streaming and virtual reality, have rigorous requirements on the network latency. Accelerating users' requests over an overlay network can help meet such rigorous latency requirement. This invention relates to frameworks and algorithms for accelerating interactive-streaming-based applications using cloud overlay routing to reduce the cost of deployment and maintenance for overlay services.

In one embodiment, the system will check whether the underlay path provided by the ISP can satisfy a user's requirements on delay and bandwidth. If yes, the underlay path will be selected to serve that user's request; otherwise, an overlay path for the user will be allocated.

In another embodiment, the goal of overlay routing is to minimize the total traffic costs but also to satisfy users' requirements on the end-to-end delay and bandwidth, considering the capacity constraints of underlay links.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIG. 1 illustrates an exemplary system for interactive-streaming-based applications using cloud overlay routing.

FIG. 2 is the flow chart of an example of overlay routing algorithm for interactive-streaming-based applications.

### DETAILED DESCRIPTION

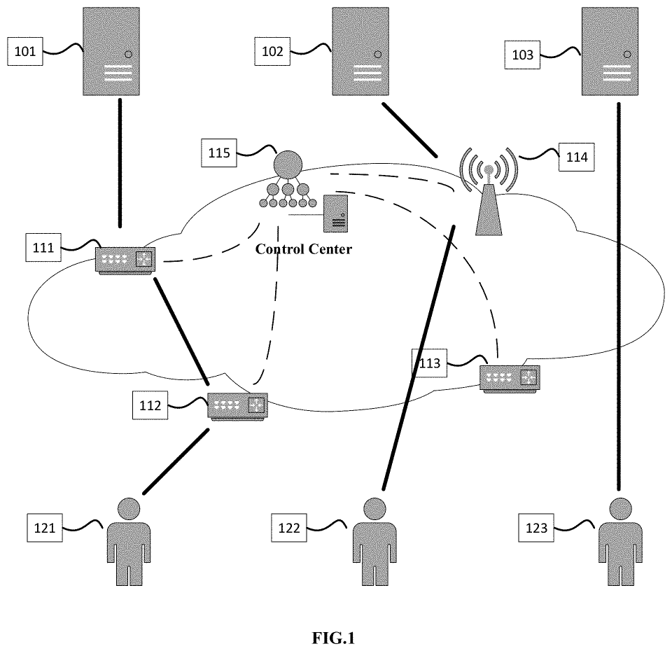

As shown in FIG. 1, in one embodiment, a cloud overlay system comprises interactive-streaming-based application servers (101, 102, 103), overlay routers (111, 112, 113, 114), a Control Center (115), and Users (121, 122, 123). Devices 111, 112, 113, 114 are chosen as overlay nodes. Overlay nodes can be any machines with suitable computing capabilities like cloud hosts or routers of different types or base stations. The connection between the overlay nodes is through the underlay path across the public Internet. The overlay nodes in FIG. 1 are rented from cloud service providers, connected with each other via the public Internet. In this way, the provider of the cloud overlay system does not need to maintain the overlay nodes themselves, lowering the operational costs. The performance of the cloud overlay system depends on deployment of overlay nodes, including the numbers and the geographical distribution of the overlay nodes deployed. The deployment cost is also a factor to be considered by the provider of the cloud overlay system. Taking the ISP's cost model into consideration, each time the overlay traffic traverses through an overlay node, an extra fee is likely required to be paid to the ISP. The Control Center 115 can choose any suitable number of overlay nodes, balancing the system performance and the overall traffic costs. For example, when the User 123 accesses the server 103 through underlay network directly, the cost of which is 1 unit due to the network access fee required by ISP. When User 122 accesses server 102 through an overlay path, in addition to the required ISP's access fee, User 122 would need to pay for extra data traffic passing the overlay node. The overall cost is therefore higher than the cost for User 123 and could be 2 units for example. Similarly, when User 121 connects to server 101 through overlay nodes 111 and 112, the costs (e.g. 3 units) are higher than User 122 because its request goes through 2 overlay nodes. Thus, higher costs are incurred when accessing interactive-streaming-based application servers through more overlay nodes. On the other hand, acceleration of performance can be optimized by deploying more overlay nodes and distributing them geographically despite incurring higher costs.

The overlay nodes are connected directly through the underlay path on the public Internet, without deploying dedicated infrastructures or building dedicated links to connect them. The server that one user connects to can be selected by the Control Center in consideration of the current overall network states, including the current network performance, the current server loads, and the geographical distribution of overlay nodes. For example, server 101, 102, 103 are idle and User 121 is close to server 101, User 122 is close to server 102, User 123 is close to server 103. Server 101, 102, 103 can be assigned to User 121, 122, 123 respectively based on their proximity in physical or network distance. In the subsequent steps, a routing path is chosen for each server-user pair.

In one embodiment, the goal of overlay routing is to minimize the total traffic costs but also to satisfy users' requirements on the end-to-end delay and bandwidth, considering the capacity constraints of underlay links. The overall delay traversing the overlay path should be less than the maximum delay requirements of the given user. The consumed bandwidth on a tunnel by all the users having requests traversing the tunnel should be less than the total bandwidth capacity for the tunnel. Also, one user's request should traverse one and only one overlay path. An overlay path should have no loop at the overlay node level. An overlay path having lower total traffic costs would normally be preferred over a path having higher costs.

If an underlay path can satisfy these requirements, it will be selected to serve the user's request directly. If the underlay path does not meet these requirements, the Control Center would determine another suitable overlay path that can satisfy the user' requests. For example, User 123 accesses server 103 directly through a direct underlay path, while User 122 accesses server 102 through one overlay node, because the underlay network does not meet User 122's requirements on the delay or bandwidth. The Control Center chooses a different path for User 121, which accesses server 101 through two overlay nodes, because this path's cost is lowest among all paths meeting User 121's requirements of the delay and bandwidth.

The Control Center has direct control over the interactive-streaming-based application servers in the system, and can balance the loads among the servers and find the most suitable server to serve different users. For example, User 121 is directed by the Control Center to connect to server 102 instead of server 101 under certain network conditions. The Control Center can also couple with shutdown of some servers by migrating the users' requests to another available server.

When the overlay network is in operation, the overlay nodes would measure the tunnel performance and report the measurements to the Control Center periodically. The tunnel performance includes the network delay, delay jitter, packet loss, underlay links, and available bandwidth. Based on these measurements, the Control Center can construct a logical network topology, which is a complete graph with the vertexes being overlay nodes and edges being the tunnels between the overlay nodes. Based on the topology, the Control Center determines a suitable path for the users.

As the Control Center has direct control over the overlay nodes, they can measure the tunnel performance between two arbitrary overlay nodes using direct measurement methodologies. For example, the Control Center can use the tool ping to measure the network delay between two nodes, use the tool traceroute to measure the links along a tunnel, and use the tool iPerf to measure the maximum achievable bandwidth along a tunnel. Indirect measurement methodologies can also be used in the overlay nodes to measure the network performance between the overlay nodes and the users.

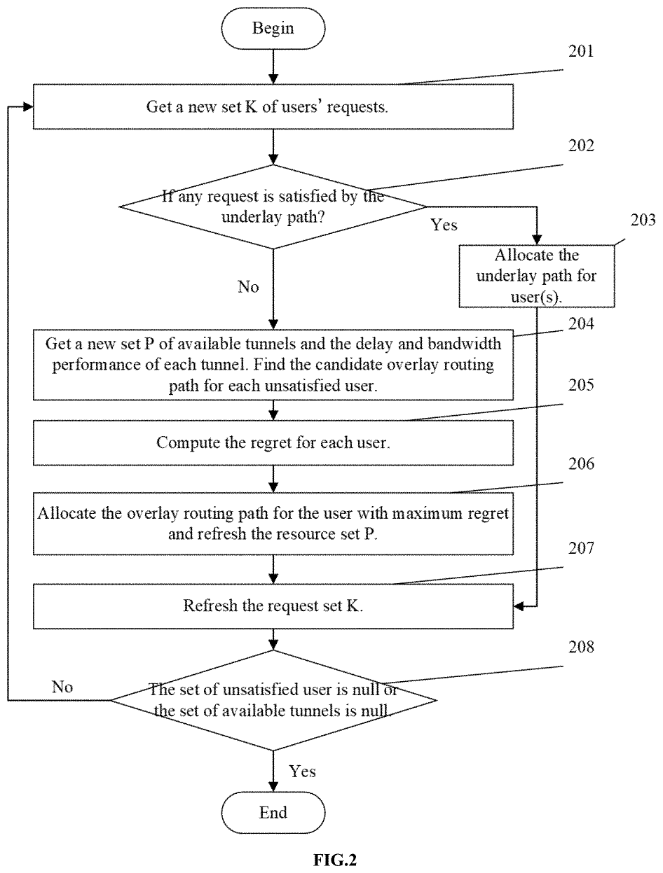

FIG. 2 illustrates an example of an overlay routing algorithm in this invention, which minimizes the total traffic costs but also satisfies the users' delay and bandwidth requirements. Specifically, at step 201, the Control Center gets a new set K of N users' requests, which have not been served: K={Kᵢ|∈1,2, . . . , N}. Specifically, the Control Center would have a set of users whose requests need to be served. Suppose the i-th user's request Kᵢ={uᵢ, s₁, dᵢ, qᵢbᵢ}, where uᵢ represents the iₜₕ user, sᵢ represents the accessed server by uᵢ, dᵢ represents the maximum delay that can be tolerated by uᵢ, q₁ represents the queuing delay of uᵢ's request in the Control Center, and bᵢ represents the minimum bandwidth required by uᵢ. In general, the initial queuing delay for any request is set to 0 as default.

In step 202, the Control Center checks whether a direct underlay path provided by the ISP can satisfy a user's requirements. If yes, then it will go to step 203 to select the underlay path for that user; otherwise, it will go to step 204 to begin selecting an overlay path for the user.

At step 203, when one or more users' requests can be satisfied using the underlay paths, the Control Center would direct the requests to go through the underlay path, then go to step 207 to refresh the users' request set K upon serving the user using the underlay paths.

In step 204, the Control Center decides a set P that includes all the candidate overlay paths for each user's request Kᵢ, according to the overlay network states. Specifically, the Control Center obtains the network performance to determine the set of the available tunnels and the available bandwidth for each tunnel. The value of allocated bandwidth is equal to the required bandwidth by the user (bᵢ). In other words, if the available bandwidth of a path is greater than the requirement for a request, only the required bandwidth would be allocated to the request. For each path R_{i,k} (the k-th feasible candidate overlay path for uᵢ) in P, the Control Center computes its path cost h(Kᵢ, R_{i,k}). Herein the path cost h(Kᵢ, R_{i,k}) is a function of the traffic cost paid to the ISP, the maximum tolerable latency dᵢ for the user, the queuing latency qᵢ of the user's request, the minimum bandwidth bᵢ required by the user, the RTT Dᵢₖ and the available bandwidth Bᵢₖ from the user to the server along the overlay path.

As an example, Equation (1) below shows a representation of path costs considering the traffic costs and the penalty for delay and bandwidth.

$$h ( {K}_{i} , {R}_{i , k} ) = {\sum }_{{P}_{a , b} ∈ {R}_{i , k}} {c}_{a , b} * {b}_{i} + λ \frac{{q}_{i}}{{d}_{i} - {D}_{ik}} + ξ \frac{{b}_{i}}{{B}_{ik}} \qquad ( 1 )$$

where cₐₘ is the bandwidth price for the tunnel P_{a,b} and Σ_{P}_{_{a,b}}_{∈R}_{_{i,k}}c_{a,b}* bᵢ is the traffic cost for the request Kᵢ along the path

$${R}_{i , k} , \frac{{q}_{i}}{{d}_{i} - {D}_{ik}}$$

is the penalty for the waiting delay,

$$\frac{{b}_{i}}{{B}_{ik}}$$

is the bandwidth penalty, λ, ξ are the coefficients for the delay penalty and bandwidth penalty, respectively. The total path costs are to be minimized while satisfying users' requirements on the end-to-end delay and bandwidth under the capacity constraints of underlay links. Specifically, the delay traversing the overlay path plus the queuing delay should be less than the maximum delay requirement for any given user. In other words, Σ_{P}_{_{a,b}}_{531 R}_{_{i,k}}d_{a,b}+qᵢ≤dᵢ. Also, the consumed bandwidth on a tunnel by all the users whose requests traverse the tunnel should be less than the overall bandwidth capacity for the tunnel:

$${b}_{i} \leq {min}_{{P}_{a , b} ∈ {R}_{i , k}} {b}_{a , b} = {B}_{i , k} .$$

Further, the allowable maximum overlay node number m and the overlay path should not traverse an overlay node more than once, which means an overlay path should have no loop in the overlay topology: Σ_{P}_{_{a,b}}_{∈R}_{_{i,k}}1<m. In this way, the path cost for every candidate overlay path is computed.

Generally, the OSP gives an overlay routing path the maximum allowable number m of overlay nodes. The larger m is, the higher the overall traffic costs are. This is because that each time the traffic passes through an overlay node, the OSP would need to pay a fee to the ISP. On the other hand, the larger m is, the better the system performance would be as traffic may traverse more overlay nodes and the performance can be accelerated accordingly. The OSP can choose an appropriate m, balancing the system performance and the overall traffic costs.

In step 205, uᵢ's regret rᵢ is defined as the path cost difference between the feasible overlay path R_{i,b} with the lowest path cost and the feasible overlay path R_{i,c} with the second lowest path cost: rᵢ=h(Kᵢ,R_{i,b})−h(Kᵢ,R_{i,c}). A regret value will be calculated for each user waiting for being allocated with an overlay path. The user with the highest regret will be allocated by the Control Center with the feasible overlay path R_{i,b} first, followed by other users with lower regret values.

In step 206, the Control Center selects the routing path for the user whose regret value is highest in the set K and indicates to the user which overlay path its request should traverse. The overlay path information can be stored in the packet header, which will lead the data packages to bypass the busy underlay network and arrive at the destination server with the least delay. After the user's request has been served, the remaining capacity of each tunnel is updated in the set P.

In step 207, upon successful allocation of an overlay path to a user, the users' request set K is updated to reflect only the users whose requests have not been satisfied. In some cases, if a path (whether overlay or underlay) is not allocated successfully to a user, the Control Center will leave the set K unchanged such that this user can be served later. Moreover, the queuing delay for the users remaining in K and the available bandwidth in the network will also be updated. When the queuing delay for a user is larger than the maximum tolerable delay for the user, the user's request will be removed from the set K and a notification will be sent to the user.

In step 208, the Control Center determines whether the entire set K is served and whether to end the overlay routing algorithm. If the set K is null or the set of available tunnels is null, which means it is either not needed or not possible to find a suitable tunnel, this algorithm will switch to end. Otherwise, it will return to step 201.

In sum, the cloud overlay routing system can avoid network congestion in the overlay network by assigning routing paths to the users considering the available bandwidth in the overlay network and in a specific order based on the path costs. This system can also reject one or more users from joining the system to maintain good experience for the users who are already in the system. Too many users joining the system may destroy the existing users' quality of experience.

In one embodiment, the overlay routing algorithm can be implemented on the application layer, making it fully controllable for optimization. The overlay routing algorithm can also be implemented in other layers and different hardware.

Each of the methods disclosed herein comprises one or more steps or actions for achieving the described method. The method steps and/or actions may be interchanged with one another and/or combined into a single step without departing from the scope of the claims. In other words, unless a specific order of steps or actions is required for proper operation of the method that is being described, the order and/or use of specific steps and/or actions may be modified without departing from the scope of the claims. It is to be understood that the claims are not limited to the precise configuration and components illustrated above. Various modifications, changes and variations may be made in the arrangement, operation and details of the systems, methods, and apparatus described herein without departing from the scope of the claims.

1. A system for accelerating clouding gaming over overlay network, comprising:
one or more interactive-streaming-based application servers,
one or more end users,
one or more overlay nodes,
one or more control centers,
wherein the control center selects which application server to serve a given end user's request and determines whether an underlay path or an overlay path should be used to serve the end user's request,
wherein the end user's request is sent to the selected application server for video data;
wherein upon determining an overlay path should be used to serve the end user's request, the control center performs an overlay routing method to construct a logical network topology with the overlay nodes as vertexes and links between the overlay nodes as the edges and selects an overlay path for the end user based on the network statuses measured and reported by the overlay nodes and said topology;
wherein information of the overlay path selected by the control center is stored in metadata encapsulated with the video data; and
wherein the overlay nodes route the video data according to the information stored in said metadata to the end user.

2. The system of claim 1, wherein the network status includes network delay, delay jitter, packet loss, underlay links, and available bandwidth of underlay links.

3. The system of claim 1, wherein the overlay routing method routes the users' requests in a regret-greedy manner, wherein a regret value is calculated for each end user whose request has not be served considering all available candidate overlay paths, wherein the regret value is calculated by computing a difference between the candidate overlay path with lowest path costs and the candidate overlay path with the second lowest traffic costs;
wherein the overlay routing method assigns overlay paths to the end users in an order according to each end user's regret value.

4. The system of claim 3, wherein the end user with the highest regret value is assigned with an overlay path first.
